(19) United States
(12) Patent Application Publication
(10) Pub. No.: US 2008/0247855 A1
(43) Pub. Date: Oct. 9, 2008

(54) Vehicle Mounted Carrier

(76) Inventors: Glen L. Lee, Cerritos, CA (US); Jeremy M. Wilkins, Huntington Beach, CA (US); Francisco J. Hernandez, Huntington Beach, CA (US); Aric Plumley, Huntington Beach, CA (US)

Correspondence Address: PLAGER LAW OFFICES, 16152 BEACG BLVD., SUITE 207, HUNTINGTON BEACH, CA, 92647, US

(21) Appl. No.: 11/697,981

(22) Filed: Apr. 9, 2007

(51) Int. Cl. B60P 1/00

(52) U.S. Cl. 414/546

(57) ABSTRACT

A vehicle mounted carrier comprising a vertical lift removably secured to a vehicle. The lift further comprising: a base removably secured to the lift and threadably engaging the lift to effectuate vertical movement, and having one or more hooks for removably securing to an article adapted to receive the hooks.

### BACKGROUND OF THE INVENTION

1. Field of the Invention

The present invention relates to removable carrier and lift that can be secured to a vehicle. More particularly, the present invention relates to a cart or other article that can be easily secured to and removed from a vehicle through vertical adjustment of the article relative to the vehicle using a lift.

2. Description of Related Prior Art

There are a number of devices currently available for securing and removing articles to a vehicle during transport. However, current devices typically accommodate bikes, skis, surfboards, and other lighter objects and are not sufficiently designed to easily secure larger articles. Larger items, such as heavy duty carts, can present greater problems during transport because of their increased load, difficulty in securing it to a vehicle, and maintaining the safety of other vehicles during transport of the article. Because there is so much weight, the cantilever load capabilities should be sufficiently distributed to allow for greater strength and greater stability of the article during transport.

Therefore, it is desirable to provide a novel attachment mechanism for a hitch-mounted carrier that can sufficiently sustain a larger article during vehicular transport, as well as vertically lift the article.

### SUMMARY OF THE INVENTION

Accordingly, it is an object of the present invention to provide a vehicle mounted carrier comprising: a lift secured to a vehicle; a base removably secured to the lift; and one or more hooks coupled to the base for removably securing an article adapted to receive the one or more hooks. It is a further object of the present invention to provide: hooks removable from the base; locking members on the hooks comprising pivoting latches with apertures that align with apertures on at least one of the one or more hooks wherein the apertures are adapted for receiving and removing a locking pin; at least one of said one or more hooks at one or more locations on said base; a housing engaging a vehicle mount comprising: a top and a bottom, and a lead screw rotatably mounted to the housing, a drive means mounted to the housing and operatively engaging the lead screw, a removable and vertically adjustable base with a sleeve nut operatively engaging the lead screw, and the base having one or more hooks for removably securing to an article adapted to receive the hooks; one or more vertical rails generally parallel to a lead screw and operatively engaging a base; a drive means comprising an electric motor for engaging a lead screw and that operatively engages the electrical system of an automobile; a drive means comprising a hand crank actuated by a handle operatively engaging a lead screw; a removable housing cover having one or more channels for allowing vertical movement of said base; at least one of one or more hooks on a base comprises a locking member for preventing the removal of an article from the hooks.

### BRIEF DESCRIPTION OF THE DRAWINGS

FIG. 1 is a rear view of a hitch-mounted article carrier with upper carrier hooks having pivoting locking latches in an unlocked and locked position.

FIG. 2 is an exploded view of an article carrier with a motor and lead screw.

FIG. 3 is an elevated perspective front view of a lift unit with a frame and hitch mount.

FIG. 4 is a side cross-sectional view of a lift unit showing rails and rail guides attached to a base.

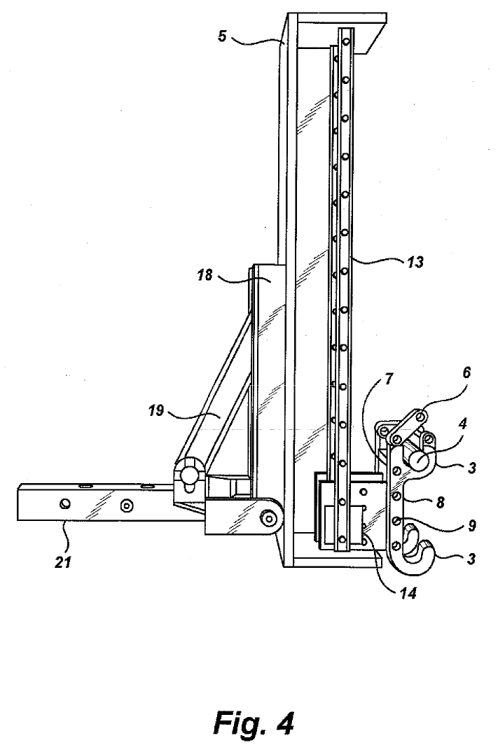

FIG. 5 shows a dual brace receiving attachment on a cart.

FIG. 6 shows a dual brace receiving attachment on a cart.

FIG. 7 shows a dual brace receiving attachment on a cart.

FIG. 8 shows a dual brace receiving attachment on a cart.

FIG. 9 shows a single brace receiving attachment on a cart.

FIG. 10 shows a single brace receiving attachment on a cart.

FIG. 11 shows a dual brace receiving attachment on a cart.

### DETAILED DESCRIPTION OF THE DRAWINGS AND PREFERRED EMBODIMENTS

A complete understanding of this invention can be gained through reference to the drawings in conjunction with a thorough review of the disclosure herein.

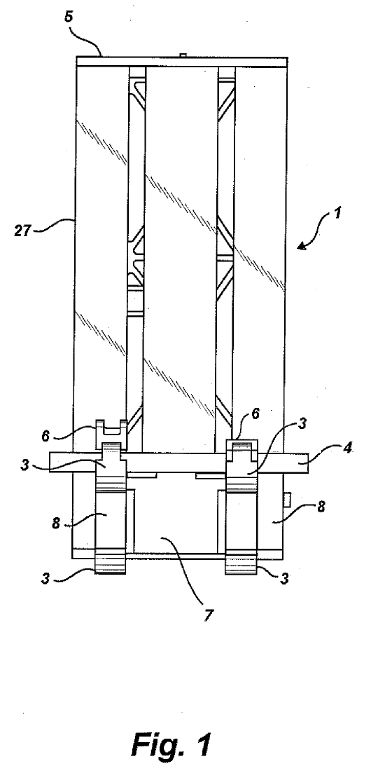

In general, the present invention is a vehicle mounted device that can bear substantially large article loads through a novel hook support. For example, FIG. 1 shows a vertical lift 1 with hooks 3 that support a receiving bar 4 secured to a cart or other article (not shown) and lifted from a ground position to an elevated position relative to a vehicle. In this preferred embodiment, vertical lift is accomplished through an electric or other drive device that resides within the lift housing 5. In this embodiment, when the cart is resting on the ground, lift hooks 3 are moved to a position sufficiently low enough to be positioned under receiving bars 4 on a cart or article and then lift is initiated through a control unit connected to a motor 12 within the housing 5 on the carrier 1. Once lift is effectuated, hooks 3 engage receiving bars 4 and lift the cart to a desired position. Alternatively, clamps 6 pivotally connected to the hooks can be secured and locked over the receiving bars 4.

During transport, carrier attachments to vehicles endure significant stress because of the constant movement transferred from the vehicle to a carrier and its attached article. This is especially true for larger loads that extend away from the vehicle resulting in greater bending moment and shear force than common vehicle-mounted article carriers. Consequently, the carrier must be able to withstand substantial stress created by horizontal forces (varied by acceleration and deceleration) and vertical forces (created by acceleration and deceleration over varied terrain) that are compounded by the article load. Therefore, a preferred embodiment for sustaining this load is accomplished by a hook or claw assembly whereby the load is distributed to the apparatus through hooks secured to a base.

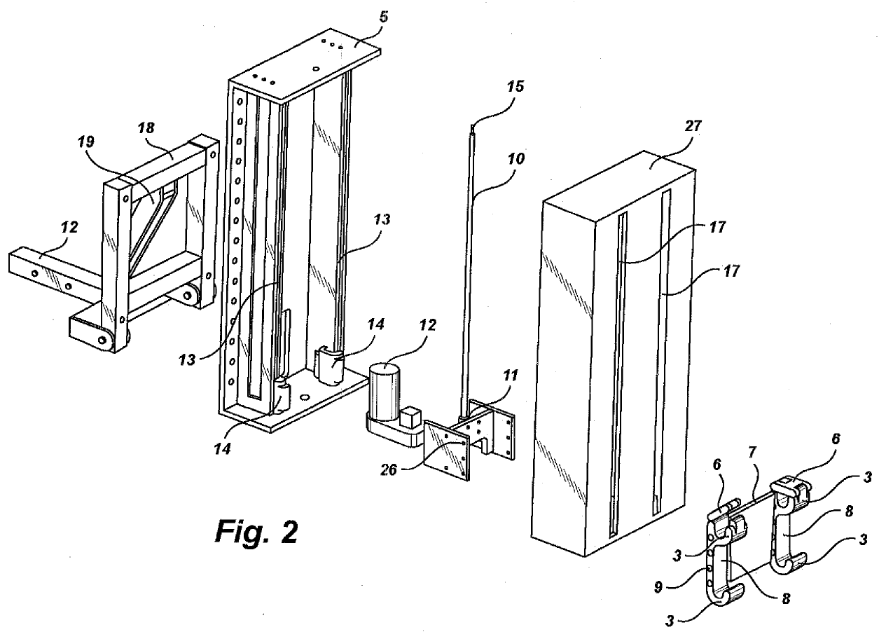

In a preferred embodiment shown in FIGS. 1 and 2, two pairs of parallel hooks 3 are spaced apart on an upper and lower portion of a base 7 to distribute the article's load. Those reasonably skilled in the art will appreciate that although a preferred embodiment shows a four hook arrangement, fewer or more could be used as a result of varying the size, width, material, and gauge of material of hooks in conformity with the load bearing capacity of the apparatus. Further, hooks need not necessarily be situated on opposing sides of base 7 but could be alternately situated, either fixed or removably, along various positions on base 7.

In an exemplary embodiment shown in the exploded view of FIG. 2, hooks 3 are comprised of a single, removable hook supports 8 with apertures 9 on hook supports 8 capable of aligning with apertures (not shown) on base 7 through which locking screws or other similar attachment can be used to secure the hook supports 8 to the base 7.

In an optimal configuration, hooks 3 are used to align with receiving bars 4 or other attachments on a cart or article with a corresponding shape acceptable for fitting onto hooks 3. As such, hooks 3 can be lowered to an optimal clearance level below receiving bars 4 and then lifted through vertical movement of the lift 1 to a desired position relative to the ground.

In tests, tolerance thresholds for the lift 1 incorporating a small electric motor exceeded 350 lbs of load bearing capacity. Preferably, materials used for the lift 1 are comprised of aluminum or titanium, either machined or cast, because of their strength and lightweight character, but other suitable materials include other metals or even reinforced composite plastics depending on the loads to be transported.

Base 7 is used to support hooks 3 and slidably engage a lead screw 10 (FIG. 2) to conduct vertical movement of an article secured to the lift 1. Base 7 threadably engages lead screw 10 through a threaded sleeve 11 that ascends or descends when lead screw 10 is rotated either by a motor or hand crank.

In an exemplary embodiment hooks 3 or other attachments are secured directly to base 7 either as a unitary machined or molded hook element(s) or, can attach to base 7 through one or more hook supports 8 that are removably secured to the base 7 so that hooks 3 and supports 8 can be realigned on base. In this exemplary embodiment, different attachment types can be normal or locking screws to prevent unwanted removal of hooks.

Hooks are secured to an article utilizing specially adapted receiving bars 4. In a preferred embodiment an article can be configured with one or more elongated bars welded or, removably secured to the article through known fastening mechanisms. (E.g., bolts, pins)

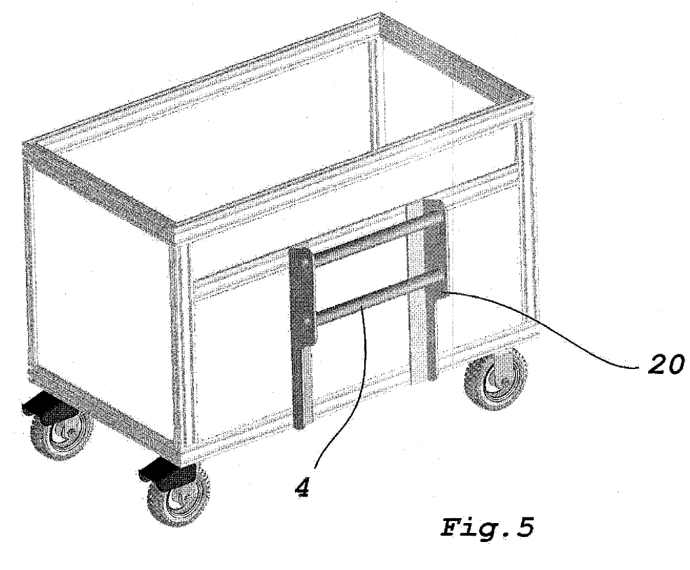

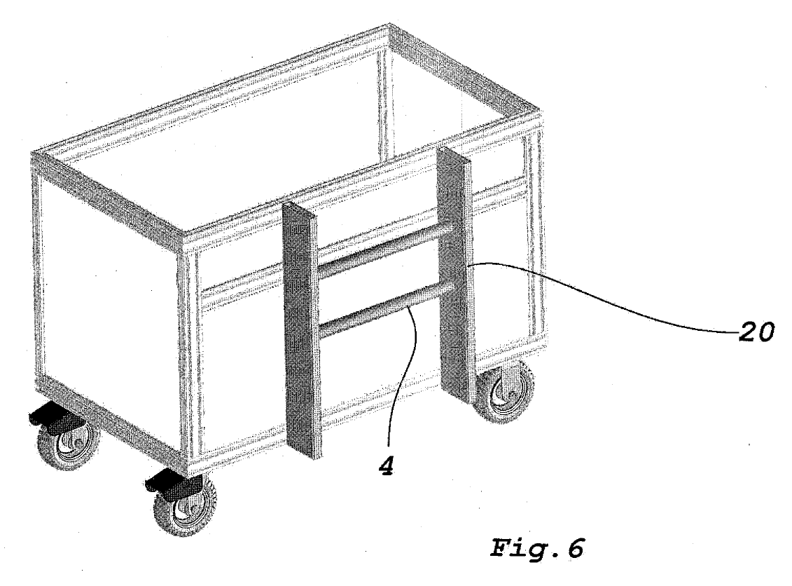

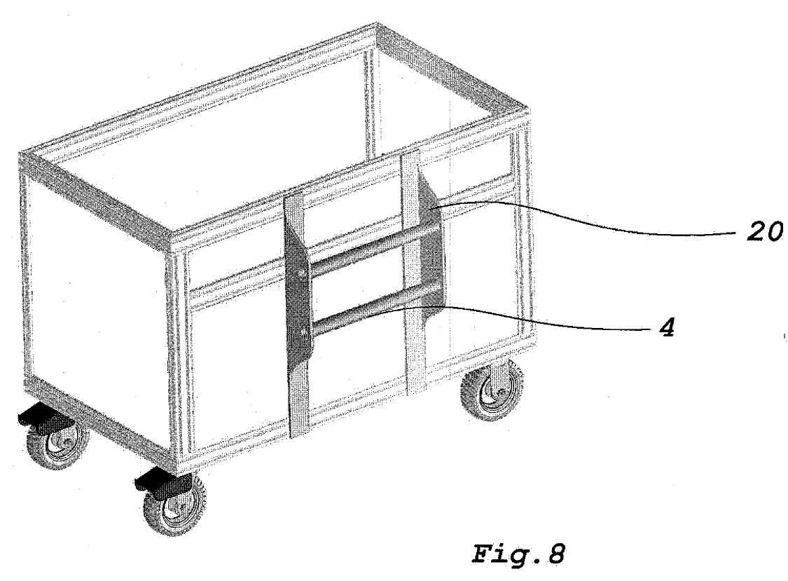

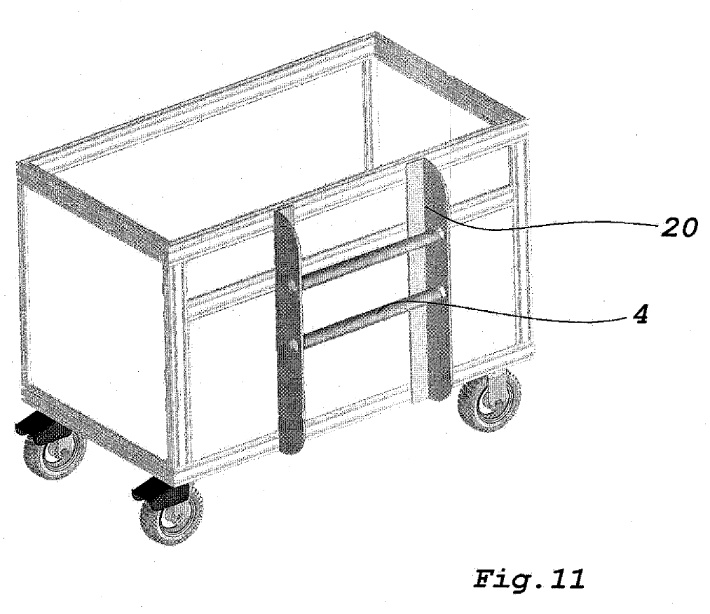

FIGS. 5 through 11 illustrate how two receiving bars 4 are secured to one or more receiving braces 20 on a cart. Although two parallel bars are shown in these Figures, size and shape are unimportant so long as they meet load bearing thresholds. Additionally, two receiving bars 4 are preferred for increased load distribution and greater stability of an article or cart during transport. However, a single bar may be used depending on the load of the object being transported. For example, a single elongated hook spanning a greater percentage of the width of base 7 could join with a similarly mated single receiving bar on a cart or article.

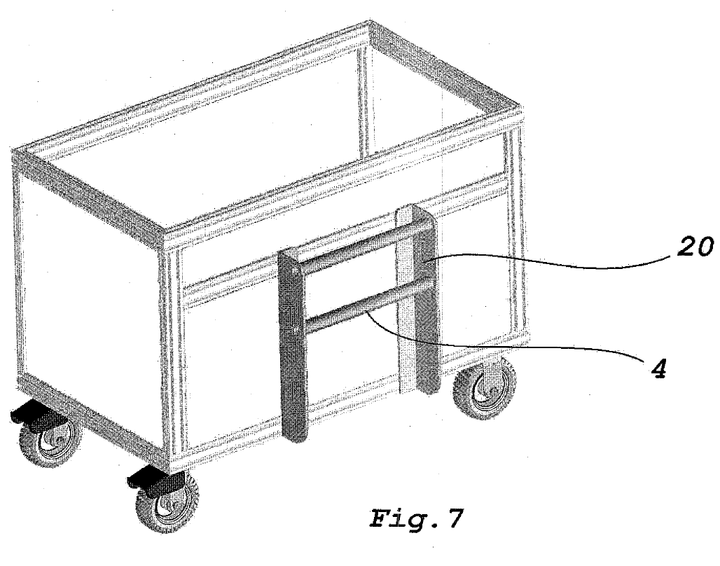

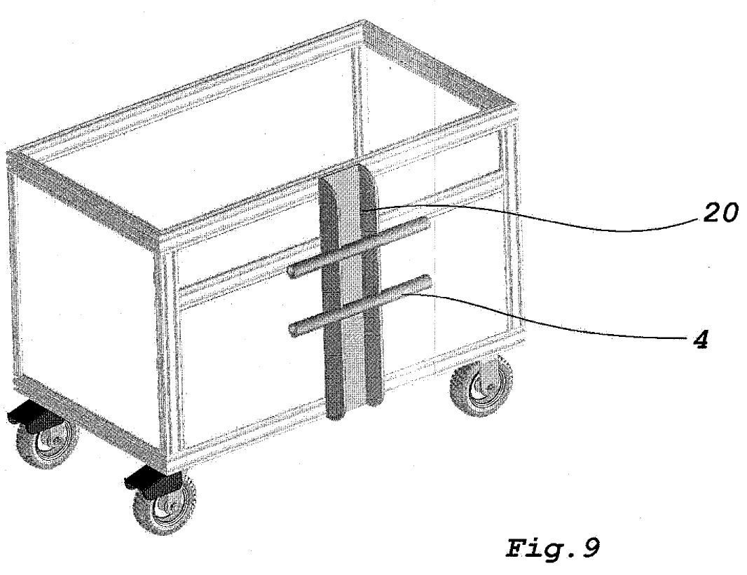

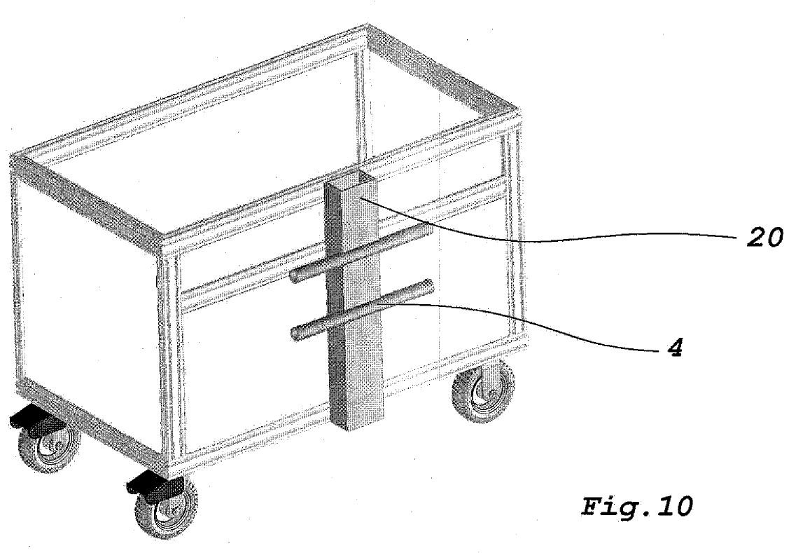

FIGS. 7 through 13 show the variety of ways in which braces 20 can be used to support one or more receiving bars 4. FIGS. 5, 6, 7, 8, and 11 show two parallel vertical braces 20 supporting two parallel horizontal receiving bars 4 sufficiently distanced to equally receive hooks 3 from a lift 1. FIGS. 9 and 10 depict a single brace 20 mounted to a cart and joined to two parallel receiving bars 4 sufficiently spaced apart to equally receive hooks from a carrier attachment.

To lift an article off the ground, vertical movement is achieved through the use of a lead screw 10 that is generally vertically relative to the lift 1. As the screw 10 is turned, the torque from turning is converted to thrust of threaded sleeve 11 such that it moves linearly along lead screw 10. It is preferred that a Precision lead screw is used. It has been found that a minimum ½ inch diameter screw be used for per 350 lbs of load. Therefore, lead screw 10 could be smaller if lead screw 10 is supported differently. Lead screw 10 should be of sufficient diameter and thread pitch in reference to the load size to be lifted to prevent back slippage when an article is raised and lowered. Likewise, an annular threaded sleeve 11 should be at least an inch in height or greater and with sufficient thread pitch to prevent back slippage on the screw 10. Pitch, material, and lubrication should be chosen to minimize the likelihood of slippage. Additionally, motor size and pitch are complementary when factored into load bearing capacity of the lift 1.

The primary concern in any lead screw system is the amount of load to be moved. The load to be moved is determinative of the proper type and size of screw to be selected. Because the type of loads referred to in this application are being moved vertically, the nut load, or the load being forced on the threaded sleeve 11 should be equal to the weight to be moved plus the friction load. Therefore, the screw 10 and sleeve 11 will need to increase proportionately with the load.

A preferred embodiment for creating vertical lift is through an electric motor that engages gears for turning lead screw 10. Electric motor 12 may be mounted on carrier and controlled by any number of control devices commonly found in the art. Further, the power source for driving the motor can be either a portable power source such as a battery or through leads and other control units engaging a vehicle electrical source. Alternatively a manual crank or ratchet may be used in lieu of a motor as discussed herein. A preferred crank and screw combination provides for a 5/16 hex that can be turned with a wrench, socket device, or built-in handle.

In a preferred embodiment, electric motors such as those found in electric drills which generate a quarter horsepower will lift 350 lbs at 0.6 inches a second. More powerful motors or ones with variable speeds may also be used to engage a lead screw 10 to effectuate faster lifting.

In an exemplary embodiment for rotating lead screw 10, a motor is mounted to engage a gear combination where lead screw 10 is axially mounted through one of the gears and the motor axle is mounted to another gear that engages the lead screw gear. (Not shown) Vertical movement is controlled by the transfer of motor force through the rotation of the gears to lead screw 10. Speed, power, and direction can vary depending on the type of motor used in addition to the size of the threading on the lead screw 10.

To provide additional support and stabilize an article during transport, rails 13 and rail guides 14 secured to base 7 are disposed on a lift 1. Here, two parallel rails 13 are disposed vertically and generally parallel on either side of lead screw 10 and base 7. Base 7 engages rails 13 through rail guides 14 that extend from base 7 or base attachments 26 and fit over rails 13. Various embodiments exist for slides including bearing slides, track rollers, slidable material, or lubricated material engaging rail slides allowing for easier vertical movement. In a preferred embodiment, heavy duty bearing slides 14 form a straddle rail arrangement that in addition to creating a vertical guide to prevent wobbling of an article, also offsets the cantilever load created by an article or cart.

Alternatively, and in another exemplary embodiment, a hand crank (not shown) can replace a motor as a motive force for turning the gears or lead screw 10 directly. A crank may be threadably attached to threading 15 on the end of a lead screw 10 thereby allowing a person to rotate lead screw 10 in either direction to create lift of base 7. This embodiment is oftentimes preferred so as to eliminate the need for added electrical connections where power may not always be available.

Those skilled in the art will readily appreciate that alternate lifting forces, such as hydraulic and pneumatic motors, are also available and could be adapted for use on carrier.

For safety reasons, it is preferred that a removable cover 27 with channel apertures 17 be adapted to fit over lift 1 allowing for unimpeded and unhampered vertical movement of base 7 and hooks 3. FIGS. 1 and 2 show a single housing cover 27 with parallel channels 17 vertically disposed on cover 27 to allow for vertical movement. Those in the art will appreciate that the shape of a cover can vary to adapt to special design preferences. Further, the base 7 can be adapted in either a single piece or as a multiple removable pieces to accommodate attachments to lead screw 10 and/or rail guides 14.

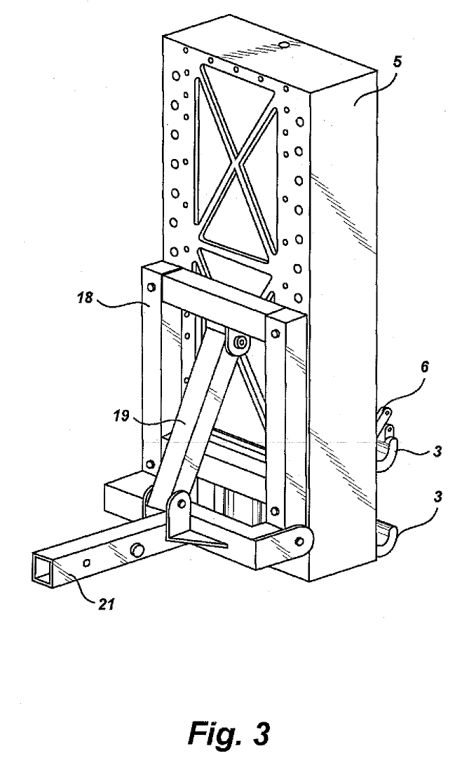

In another preferred attachment embodiment shown in FIG. 3, lift 1 pivots relative to a vehicle to provide clearance for a tailgate or other vehicle hatch without having to remove the lift 1 from a vehicle mount 21. This is accomplished through a frame 18 attachment that is bolted, welded, or otherwise firmly secured to lift unit 1 but pivots relative to a hitch mount 21. To further support the cantilever load, a support arm 19 is also pivotally mounted to frame 18 and hitch mount 21.

Alternatively, and because a pivoting frame assembly could be the cause of some wobbling, a frame 18 could be welded or otherwise permanently affixed to a hitch mount 21 and a support arm 19 could similarly be welded to the hitch mount 21 and frame 18.

Although several embodiments have been described, the same should not be construed as limited thereby to specific features mentioned herein, but include various other equivalent features and should only be limited in accordance with the claims appended hereto. It is understood that any suitable changes or substitutions may be made without departing from the spirit and scope of the invention.

I claim:

1. A vehicle mounted carrier comprising:
a lift comprising means for securing to a vehicle;
a base removably secured to the lift; and
one or more hooks coupled to said base for removably securing to an article adapted to receive said one or more hooks.

2. The vehicle mounted carrier of claim 1 wherein said hooks are removable from said base.

3. The vehicle mounted carrier of claim 1 wherein said one or more hooks further comprise a locking member comprising a pivoting latch with an aperture that aligns with an aperture on at least one of said one or more hooks wherein said apertures are adapted for receiving and removing a locking pin.

4. The vehicle mounted carrier of claim 1 wherein said one or more hooks are removable from said base and wherein said base is adapted to receive at least one of said one or more hooks at one or more locations on said base.

5. A vehicle mounted carrier comprising:
a vehicle mount;
a housing engaging the vehicle mount comprising: a top and a bottom, and a lead screw rotatably mounted to the housing;
a drive means mounted to the housing and operatively engaging the lead screw;
a removable and vertically base with a sleeve nut operatively engaging the lead screw; and
the base having one or more hooks for removably securing to an article adapted to receive said hooks.

6. The vehicle mounted carrier of claim 5 wherein said housing comprises one or more vertical rails generally parallel to said lead screw and operatively engaging said base.

7. The vehicle mounted carrier of claim 5 wherein said drive means is an electric motor that further engages the electrical system of an automobile.

8. The vehicle mounted carrier of claim 5 wherein said drive means is a hand crank actuated by a handle operatively engaging the lead screw.

9. The vehicle mounted carrier of claim 5 further comprising a removable housing cover having one or more channels for allowing vertical movement of said base.

10. The vehicle mounted carrier of claim 1 wherein at least one of said one or more hooks comprises a locking member for preventing the removal of said article from said hooks.
